(19) United States
(12) Patent Application Publication
(10) Pub. No.: US 2018/0192616 A1
(43) Pub. Date: Jul. 12, 2018

(54) Dog Harness

(71) Applicants: Danielle Leyton, Rancho Cucamonga, CA (US); Cleigh Berman, Rancho Cucamonga, CA (US)

(72) Inventors: Danielle Leyton, Rancho Cucamonga, CA (US); Cleigh Berman, Rancho Cucamonga, CA (US)

(21) Appl. No.: 15/400,905

(22) Filed: Jan. 6, 2017

(51) Int. Cl. A01K 27/00; A01K 29/00; A01K 13/00

(52) U.S. Cl. CPC A01K 27/002; A01K 13/007; A01K 29/00; A01K 27/005

(57) ABSTRACT

A dog harness which securely retains a shoe on each paw of a dog during any kind of movement of the dog. The dog harness mainly includes an adjustable harness and one or more attachment elements. The adjustable harness is configured to be worn over the head of the dog through a frontal opening of the adjustable harness, and the adjustable harness comprises a back portion and one or more leg portions. The back portion of the adjustable harness is configured to be supported on a back of the dog, and each leg portion of the adjustable harness is configured to conform around each leg of the dog. The attachment elements extend from a bottom end of each leg portion, and each attachment element is configured to fasten the shoe on each paw of the dog.

### FIELD OF THE INVENTION

The present invention relates to a harnessing device used to secure shoes on the paws of a dog. More particularly, the present invention relates to a dog harness used for securing the shoes on the paws of dogs.

### BACKGROUND

There are a lot of harnessing devices available in the market which are used to secure dogs used for domesticating purposes, as well as for dogs which are trained to assist in law enforcement, for example, K-9 dogs. The available harnessing devices vary in size and design according to the size of the dog, as well as for the purpose for which the dog is used. Most harnessing devices are configured to cover the torso portion that considerably covers the back and lateral sides of a torso of the dog, and few of the other harnessing devices are further configured to stretch across the legs of the dog to secure the harnessing device over the body of the dog. However, the paws of the dog are the parts of the dog's body which make direct contact with the ground, soil, or the pavement. Therefore, such dogs which live in harsh climatic conditions of high heat, humidity or cold, might develop chances of infection on the paws, if left uncovered. Another issue is, when the dogs which are domesticated in areas where there are rough terrains, the dog might develop chances of injuring their paws, if they tread such terrains with their uncovered paws, or un-protected paws.

The harnessing devices in the current state of art does not address the above-mentioned issues. The conventional harnessing devices only address the protection which can be provided by securing the body of the dog, and not the paws. As discussed above, even though the paws of the dogs are strong and rigid to withstand normal weather conditions and terrains, it might be subjected to infection or injury if not well protected under harsh conditions. However, some of the conventional harnessing devices do suggest some solutions to protect the paws of the dogs which mainly comprise the provision of shoes which can be worn on the paws. But none of the prior art harnessing devices disclose a structure which can securely retain the shoes on the paws of the dog under any rough climatic condition or terrain. Therefore, there is a need for dog harnessing device which can firmly retain the shoes on each paw of the dog under any harsh climatic conditions or rough terrains.

### SUMMARY OF THE INVENTION

The dog harness disclosed here is a one-piece harness boots/shoes system which slips on and around all the four legs of a dog, to ensure that the boots/shoes did not fall off from dog's paw. The dog harness disclosed here is configured to securely retain a shoe on each paw of a dog during any kind of movement of the dog. The dog harness mainly comprises an adjustable harness and multiple attachment elements. The adjustable harness is configured to be worn over the head of the dog through a frontal opening of the adjustable harness, and the adjustable harness comprises a back portion and one or more leg portions. The back portion of the adjustable harness is configured to be supported on a back of the dog, and each leg portion of the adjustable harness is configured to conform around each leg of the dog. The attachment elements extend from a bottom end of each leg portion, and each attachment element is configured to fasten the shoe on each paw of the dog.

In an embodiment, the dog harness further comprises a support strap configured to conform around the back and chest of the dog, and the support strap is configured to support the adjustable harness on the back of the dog via fastening the support strap with an adjustable clip. In an embodiment, a portion of the support strap is sewn on the adjustable harness, and one or more D-rings are connected to the support strap to allow a user to connect a leash. In an embodiment, each attachment element extends from the leg portion of the adjustable harness to fasten the shoe on each paw of the dog through an inside section and an outside section of each leg of the dog. In an embodiment, the attachment element is an adjustable strap, where a first end of the adjustable strap is fastened to the shoe, and a second end of the adjustable strap is hooked to the bottom end of the leg portion of the adjustable harness. In an embodiment, the attachment element is a stretchable strap, where a first end of the stretchable strap is sewn to the shoe, and a second end of the stretchable strap is sewn to the leg portion of the adjustable harness.

### BRIEF DESCRIPTION OF THE DRAWINGS

FIG. 1A exemplarily illustrates a front perspective view of the dog harness worn on the body of the dog.

FIG. 1B exemplarily illustrates a front perspective view of another embodiment of the dog harness worn on the body of the dog.

FIG. 2 exemplarily illustrates a side perspective view of an embodiment of the shoe worn on each paw of the dog.

FIG. 3 exemplarily illustrates a perspective view of the sole of the shoe shown in FIG. 2.

### DETAILED DESCRIPTION OF THE INVENTION

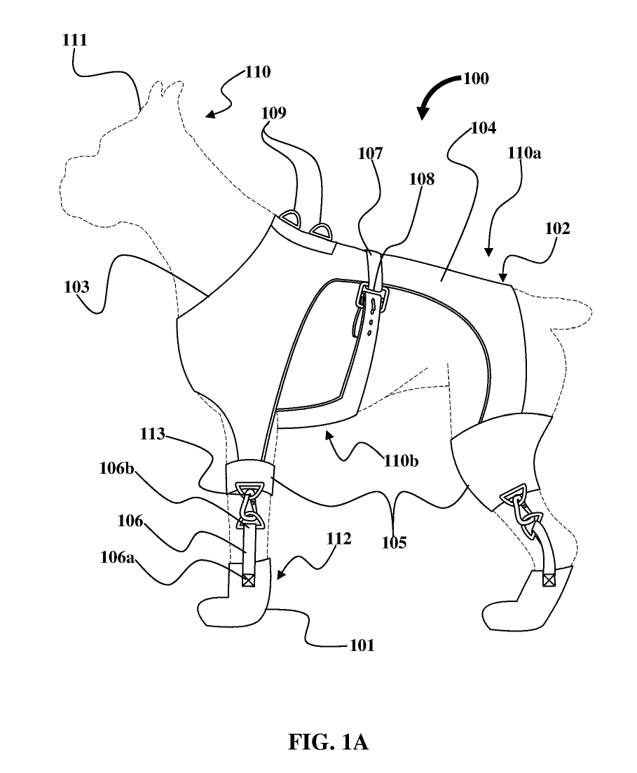

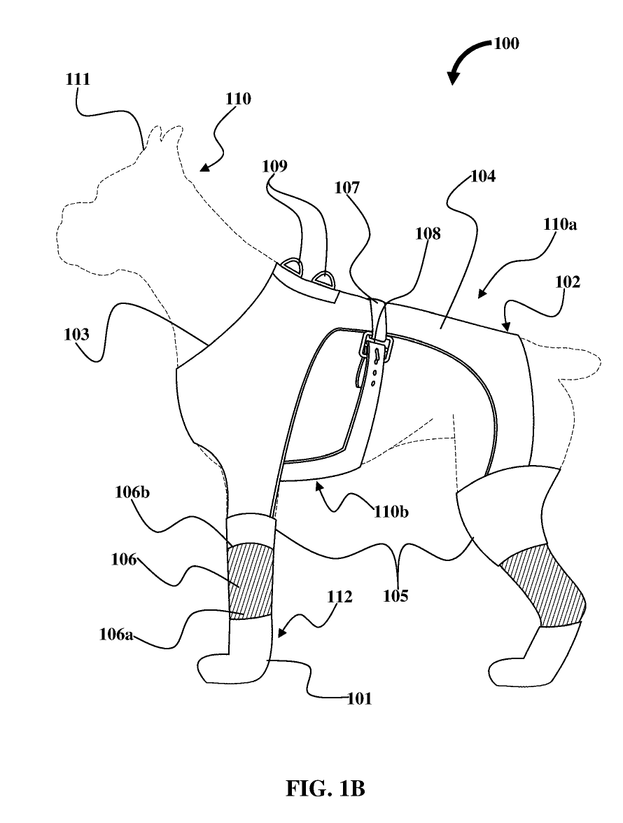

FIG. 1A exemplarily illustrates a front perspective view of the dog harness 100 worn on the body of the dog 110, and FIG. 1B exemplarily illustrates a front perspective view of another embodiment of the dog harness 100 worn on the body of the dog 110. In places where dogs 100 survive under severe climatic conditions which include extreme heat/cold, or in places where they need to move through rough terrains, conventional harnessing straps are worn on the body of the dog 110 which include a set of shoes 101 which are worn on each paw 112 of the dog 110 to secure the paws 112 of the dog 110. However, such extreme climatic conditions and rough terrains can cause these conventional harnessing straps to fail, and this may cause the shoes 101 to fall off from the paws 112 of the dog 110 causing injury. The dog harness 100 disclosed here addresses the issue mentioned above and provides adequate solution to firmly secure the shoes 101 on the paws 112 of the dog 110.

The dog harness 100 disclosed here is a one-piece harness boots/shoes 101 system which slips on and around all the four legs of a dog 110 to ensure that the boots/shoes 101 do not fall off from dog's 110 paw 112. The dog harness 100 disclosed here is configured to securely retain a shoe 101 on each paw 112 of a dog 110 during any kind of movement of the dog 110 through any climatic conditions or rough terrains. The dog harness 100 mainly comprises an adjustable harness 102 and multiple attachment elements 106. The adjustable harness 102 is configured to be worn over the head of the dog 110 through a frontal opening 103 of the adjustable harness 102, and the adjustable harness 102 comprises back portion 104 and one or more leg portions 105. The back portion 104 of the adjustable harness 102 is configured to be supported on a back 110a of the dog 110. The adjustable harness 102 is made of a flexible material and comprises pre-designed sections which conform to the shape of the body parts of the dog 110. That is, the adjustable harness 102 is initially worn over the head 111 via the frontal opening 103, and then the back portion 104 rests on the back of the dog 110.

Now, each leg portion 105 of the adjustable harness 102 is configured to conform around each leg of the dog 110. For example, each paw 112 of the dog 110 can be inserted, one at a time, into each leg portion 105 of the adjustable harness 102 which are designed to receive the paw 112 of the dog 110. This way, the dog harness 100 firmly fits to the body of the dog 110, and there is no chance of the dog harness 100 slipping off the body of the dog 110. However, the primary purpose of the dog harness 100 is to firmly secure a shoe 101 on each paw 112 of the dog 110, and to meet this requirement, suitable attachment elements 106 are introduced in the dog harness 100. Therefore, the attachment elements 106, extend from a bottom end of each leg portion 105, and each attachment element 106 is configured to fasten the shoe 101 on each paw 112 of the dog 110. The linkage between the adjustable harness 102 and the shoe 101 via the attachment element 106 provides a significant amount of added support to the shoes 101 worn on the paws 112 of the dog 110 which avoids any kind of slippage of the shoes 101 from the paws 112 due to harsh climatic conditions or rough terrains.

In an embodiment, the dog harness 100 further comprises a support strap 107 configured to conform around the back 110a and chest 110b of the dog 110, where the support strap 107 is configured to support the adjustable harness 102 on the back 110a of the dog 110 via fastening the support strap 107 with an adjustable clip 108. The support strap 107 extends from below the belly, or proximal to the chest 110b, of the dog 110 towards the top of dog's 110 back, and is fastened at the back 110a with the help of the adjustable clip 108. The adjustable clip 108 as shown in FIGS. 1A-1B are, for example, clip-on buckle type belts which can be tightened according to the size of the dog 110 to support the adjustable harness 102 on the body of the dog 110.

In an embodiment, a portion of the support strap 107 is sewn on the adjustable harness 102, and one or more D-rings 109 are connected to the support strap 107 to allow a user to connect a leash. The leash can be connected to the D-rings 109 which are firmly fastened to the adjustable harness 102. Conventionally, the leash is connected to a dog collar, and the dog collar can exert considerable amount of stress on the neck of the dog 110 when the user pulls the dog 110 with the help of the leash. This is because the pulling force from the user is distributed only through the dog collar. However, since the adjustable harness 102 is firmly fastened to the body of the dog 110, the stress that is normally developed on the neck of the dog 110 due to the dog collar can be evenly distributed through the adjustable harness 102. In an embodiment, each attachment element 106 extends from the leg portion 105 of the adjustable harness 102 to fasten the shoe 101 on each paw 112 of the dog 110 through an inside section and an outside section of each leg of the dog 110. That is, there are a pair of attachment elements 106 connected across each leg of the dog 110 so that each attachment element 106 of the pair extends across the inside section and the outside section of the legs to provide additional stability to the shoes 101 worn on the paws 112 of the dog 110.

Referring to FIG. 1A, the embodiment shows that the attachment element 106 is an adjustable strap, where a first end 106a of the adjustable strap is fastened to the shoe 101, and a second end 106b of the adjustable strap is hooked to the bottom end of the leg portion 105 of the adjustable harness 102. The adjustable strap is in the form on a conventional belt which is fastened to the shoe, and the second end 106b of the adjustable strap is hooked to the leg portion 105 via swivel clips 113 which allow a user to quickly detach the shoes 101 from the paw 112 of the dog 110 when the dog harness 100 is not in use. Referring to FIG. 1B, the embodiment shows that the attachment element 106 is a stretchable strap, where a first end 106a of the stretchable strap is sewn to the shoe 101, and a second end 106b of the stretchable strap is sewn to the leg portion 105 of the adjustable harness 102. The stretchable strap stretches across each leg of the dog 110 when the shoes 101 are worn on each paw 112 of the dog 110.

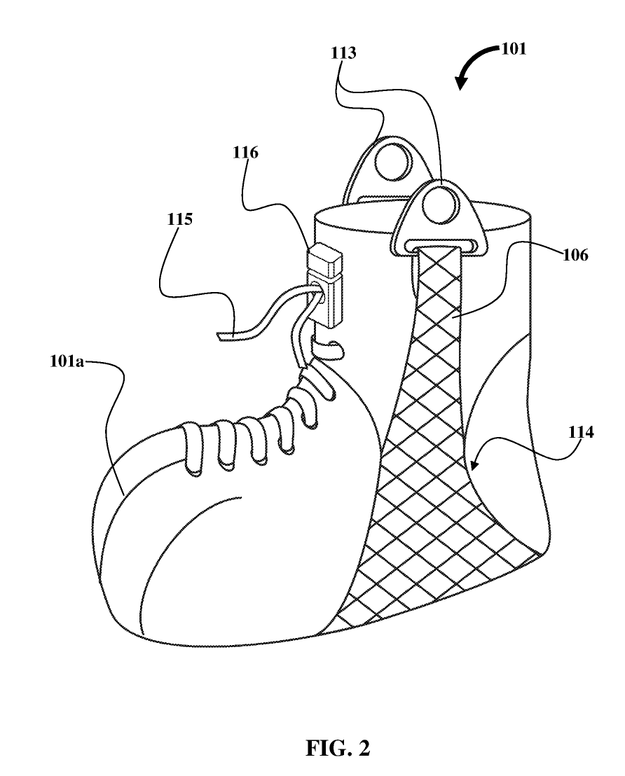

FIG. 2 exemplarily illustrates a side perspective view of an embodiment of the shoe 101 worn on each paw 112 of the dog 110. The shoe 101 comprises swivel clips 113 attached to attachment elements 106 or straps which allow the rotation of the shoe 101 along, for example, 120 degrees ‘angle. The straps 106 comprising the swivel clips 113, are sewn on both sides of the shoe 101. The material of the shoe 101 is durable, water proof and flexible. The shoe 101 also comprises a pivot section 114 constructed along an ankle portion of the shoe 101 which can flex along with the movement of the dog's 110 paw 112. In other words, the hour-glass side design at the pivot section 114 allows for forward and backward movement of the paw 112, and further allows the shoe 101 to pivot in both directions, allowing the dog 110 a natural movement when walking or running.

The shoe 101 also comprises a very durable rubber sole which is designed to resemble the bottom pad of the dog's 110 paw 112. A toe section 101a of the shoe 101 is pleated, using the same flexible, waterproof material as the shoe 101. In other words, toe section 101a is pleated to conform to a shape of the paw 112 of the dog 110. The toe section 101a further comprises an arch resembling the natural arch of a dog's 110 paw 112. To give added protection, the rubber sole material extends upward, and over the toe section 101a of the shoe 101, giving the look of a dog's 110 paw 112. The shoe 101 also comprises a draw string 115 configured to securely fit the shoe 101 to the paw 112 of the dog 110, that is, so that a user can quickly pull and adjust the fitting of the shoe 101 on the paw 112. A slip lock 116 is also provided along with the draw string 115 to tighten the draw string 115 in a quick manner. The shoe 101 also comprises memory foam lined within the inner sole of the shoe 101 to provide added comfort and protection inside the shoe 101. The shoe 101 is further designed with bright, waterproof, fashionable colors with reflective safety strips for easy identification.

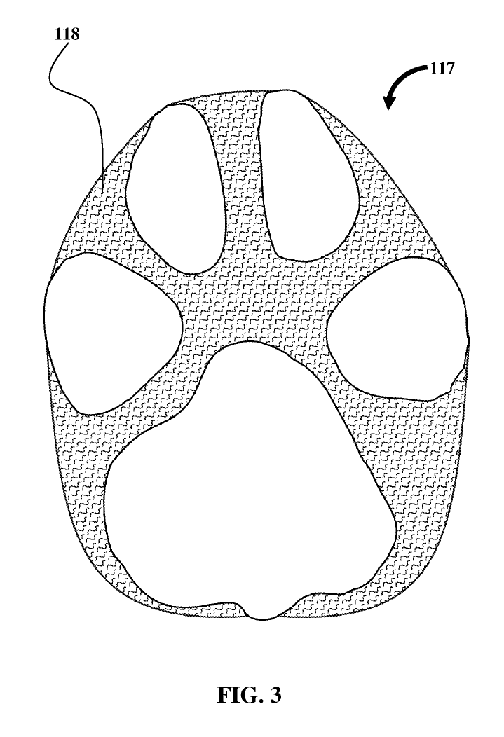

FIG. 3 exemplarily illustrates a perspective view of the sole 117 of the shoe 101 shown in FIG. 2. The sole 117 of the shoe 101 is made of, for example, highly durable shoe rubber. The bottom sole 117 is designed to duplicate the bottom of a dog's 110 paw 112 using the pads 118 where the claws extend over the edge of the toe, providing the shoe 101 with extra protection.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

I claim:

1. A dog harness configured to securely retain a shoe on each paw of a dog, the dog harness comprises;
an adjustable harness configured to be worn over the head of the dog through a frontal opening of the adjustable harness, wherein the adjustable harness comprises;
a back portion configured to be supported on a back of the dog; and
one or more leg portions, wherein each leg portion is configured to conform around each leg of the dog; and
one or more attachment elements extending from a bottom end of each leg portion, wherein each attachment element is configured to fasten the shoe on each paw of the dog.

2. The dog harness of claim 1, further comprising a support strap configured to conform around the back and chest of the dog, wherein the support strap is configured to support the adjustable harness on the back of the dog via fastening the support strap via an adjustable clip.

3. The dog harness of claim 1, wherein a portion of the support strap is sewn on the adjustable harness, wherein one or more D-rings are connected to the support strap to allow a user to connect a leash.

4. The dog harness of claim 1, wherein each attachment element extends from the leg portion of the adjustable harness to fasten the shoe on each paw of the dog through an inside section and an outside section of each leg of the dog.

5. The dog harness of claim 4, wherein the attachment element is an adjustable strap, wherein a first end of the adjustable strap is fastened to the shoe, and a second end of the adjustable strap is hooked to the bottom end of the leg portion of the adjustable harness.

6. The dog harness of claim 4, wherein the attachment element is a stretchable strap, wherein a first end of the stretchable strap is sewn to the shoe, and a second end of the stretchable strap is sewn to the leg portion of the adjustable harness.

7. The dog harness of claim 1, wherein the shoe comprises a pivot section constructed along an ankle portion of the shoe, wherein the pivot section is configured to flex along with a movement of the dog's paw.

8. The dog harness of claim 1, wherein the shoe comprises a toe section, wherein the toe section is pleated to conform to a shape of the paw of the dog.

9. The dog harness of claim 1, wherein the shoe comprises a draw string configured to securely fit the shoe to the paw of the dog via a slip lock.
